(19) United States
(12) Patent Application Publication
(10) Pub. No.: US 2003/0033252 A1
(43) Pub. Date: Feb. 13, 2003

(54) Methods and systems for check processing using blank checks at a point-of-sale

(76) Inventors: Kelly A. Buttridge, Schenectady, NY (US); Ronald N. Comstock, Central Bridge, NY (US); Lawrence J. Friedman, Clifton Park, NY (US); Michael A. Gulli, Gansevoort, NY (US)

Correspondence Address: HESLIN ROTHENBERG FARLEY & MESITI PC, 5 COLUMBIA CIRCLE, ALBANY, NY, 12203, US

(21) Appl. No.: 09/927,065

(22) Filed: Aug. 9, 2001

(51) Int. Cl. G06F 17/60

(52) U.S. Cl. 705/45

(57) ABSTRACT

A system is disclosed in which in one embodiment includes a point-of-sale terminal or cash register which is connected to a check imager, a MICR (magnetic ink character recognition) reader, biometric sensor, and a printer. The system integrates electronic check processing into retail operations such as items at a grocery checkout and allows customers to pay for goods or services with a blank check and without the need to without write out or sign the blank check. One embodiment of a method for check posting includes receiving and storing a transaction amount, checking account information from a blank check, an electronic image of a face of the blank check, and biometric information from an owner of the checking account such as an electronic image of a handwritten signature or fingerprint from an owner of the checking account. An electronic check posting transaction request may be generated from the transaction amount and the checking account information and forwarded for settlement.

### FIELD OF THE INVENTION

The present invention relates generally to the payment of goods using checks, and more particularly, the present invention relates to methods and systems for check processing using blank checks at a point-of-sale.

### BACKGROUND OF THE INVENTION

Checkout at a grocery store often involves payment by a customer using a check. A drawback with customers paying by checks is that it requires the customer to fill out the check, e.g., write out the transaction amount, the payee name, and sign and date the check. Paying by check often slows down the checkout of customers in a checkout lane.

In addition, checks are one of the most expensive tender methods in retail. One of the largest costs involved with tendering payment by checks is bank fees. One way to reduce costs is to utilize an automated clearing house (ACH). The use of ACH in retail stores has been typically confined to stand-aside processing in which the transaction is processed first on a cash register system and then through a separate ACH system at the point-of-sale lane or through a backroom processing where all the checks taken at the cash register are processed using a separate ACH system in a different location after the sales have been concluded, e.g., in an office of the store at the end of the day. While the existing processes reduce bank fees, additional costs are incurred due to increased labor expenses.

Various approaches at checkless transactions have been attempted. For example, U.S. Pat. No. 5,832,463 issued to Funk discloses systems and methods for “checkless” check transactions such as at point-of-sale transactions. In one embodiment, an automated checkless check transaction system includes an input device for receiving checking account information and a check amount of a check drawing on a checking account provided in a transaction. A device is also provided for electronically capturing an image of the face of a completed check including the identification of the payee, the transaction amount, and the account owner's signature. The checking account information, the check amount, and the check image are then transmitted electronically to a checkless transaction system. The paper check may be truncated or marked in some way to indicate that it has been processed and returned to the customer. The checkless transaction system converts the check transaction into an electronic ACH, debit card, or any other suitable transaction where the check amount is electronically presented to the institution drawn on or agent for collection and funding. A separate image database may also be implemented to maintain and store only the captured check images for research purposes.

U.S. Pat. No. 5,053,607 issued to Carlson et al. discloses a check processing device particularly adapted for retailer/customer use at the point-of-sale through use of a MICR (magnetic ink character recognition) read head means, printer means, and keypad means which feed information into a CPU which communicates, through an existing telecommunication system, with the customer's bank and the retailer's bank in order to transfer funds from the account of the customer to the account of the retailer. The system requires that the customers fill out and sign their checks, endorsement and cancellation data be printed on the checks, and the canceled checks then returned back to the customers.

U.S. Pat. No. 6,164,528 issued to Hills et al. discloses a point-of- sale system designed to read information from a consumer's “blank” check, with a subsequent debiting of a consumer's account and crediting a merchant's account for the goods or services provided. The point of sale system is designed to read the MICR number from a consumer's “blank” check in order to verify that a consumer has an appropriate balance to conduct the transaction with a given merchant. If the check is approved, a terminal displays a message noting the approval and the check is returned to the consumer. A printer further makes a paper record of the transaction and the consumer places required information on the paper receipt such as name, street address, city, state, zip code, and telephone number, and signs the receipt expressly authorizing the transaction. Thereafter, the transaction information is transmitted to a central computer system which verifies the consumer's credit worthiness and stores the transaction event information for subsequent bank reconciliation via an ACH or other competing network. The invention eliminates the need for paper checks with all bank reconciliation being accomplished electronically. Additionally, the system allows for the consumer's check to be written on and thereafter voided, canceled, and returned to the consumer.

There is a need for further methods and systems for processing checks using blank checks at a point-of-sale.

### SUMMARY OF THE INVENTION

In a first aspect, the present invention provides a method for enabling check processing using a blank check. The method includes receiving a transaction amount, checking account information from a blank check, and an electronic image of a face of the blank check.

In a second aspect, the present invention provides a method for enabling check processing using a blank check in which the method includes receiving a transaction amount, checking account information from a blank check, and biometric information from an owner of the checking account.

In a third aspect, the present invention provides a method for check processing using a blank check in which the method includes receiving a transaction amount, checking account information from a blank check, an electronic image of a face of the blank check, and biometric information from an owner of the checking account, generating an electronic check posting transaction request from the transaction amount and the checking account information, and forwarding the electronic check posting transaction request for settlement.

In a fourth aspect, the present invention provides a method for enabling check processing using a blank check at a point-of-sale. The method includes receiving at the point-of-sale a blank check from a customer at the point-of-sale, receiving at the point-of-sale a transaction amount, checking account information from a blank check, an electronic image of a face of the blank check, and biometric information from an owner of the checking account. T he transaction amount, the checking account information, the electronic image of a face of the blank check, and the biometric information are stored, and indicia is printed on the face of the blank check so as to void the blank check before returning the voided blank check to the customer.

In a fifth aspect, the present invention provides a method for check processing using a blank check at a point-of-sale in which the method includes receiving at the point-of-sale a blank check from a customer, receiving at the point-of-sale a transaction amount, checking account information from a blank check, an electronic image of a face of the blank check, and biometric information from an owner of the checking account. The transaction amount, the checking account information, the electronic image of a face of the blank check, and the biometric information are stored and indicia is printed on the face of the blank check so as to void the blank check. The voided blank check is returned to the customer. An electronic check posting transaction request is generated from the transaction amount, and the checking account information, and the electronic check posting transaction request is forwarded for settlement.

In a sixth aspect, the present invention provides a method for warehousing information relating to check transactions. The method includes storing in at least one data storage unit a transaction amount, checking account information from a blank check, an electronic image of a face of the blank check, and biometric information from the owner of the checking account.

In a seventh aspect, the present invention provides a system for enabling check processing using a blank check. The system includes a processor for receiving a transaction amount, checking account information from a blank check, an electronic image of a face of the blank check, and biometric information from an owner of the checking account. The processor is also operable for transferring the transaction amount, the checking account information, the electronic image of a face of the blank check, and the biometric information to a data storage unit.

In an eighth aspect, the present invention provides at least one program storage device readable by a machine, tangibly embodying at least one program of instructions executable by the machine to perform a method for enabling check processing using a blank check. The method includes receiving a transaction amount, checking account information from a blank check, an electronic image of a face of the blank check, and biometric information from an owner of the checking account. The transaction amount, the checking account information, and the electronic image of the face of the blank check, and the and biometric information is transferred to a data storage unit.

In a ninth aspect, the present invention provides an article of manufacture comprising at least one computer usable medium having computer readable program code means embodied therein for use in check processing using a blank check. The computer readable program code means in the article of manufacture includes computer readable program code means for causing a computer to receive a transaction amount, checking account information from a blank check, an electronic image of a face of the blank check, and biometric information from an owner of the checking account. An electronic check posting transaction request is generated from the transaction amount and the checking account information, and the electronic check posting transaction request is forwarded for settlement.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a block diagram of one embodiment of a system for check processing using a blank check at a point-of-sale according to the present invention;

FIG. 2 is a flowchart of one embodiment of a method for check processing according to the present invention using the system shown in FIG. 1;

FIG. 3 is a flowchart of one embodiment of a batch check posting process using the system of FIG. 1;

FIG. 4 is a block diagram of another embodiment of a system for check processing using a blank check at a point-of-sale according to the present invention; and

FIG. 5 is a block diagram of another embodiment of a system for check processing using a blank check at a point-of-sale according to the present invention.

### DETAILED DESCRIPTION OF THE INVENTION

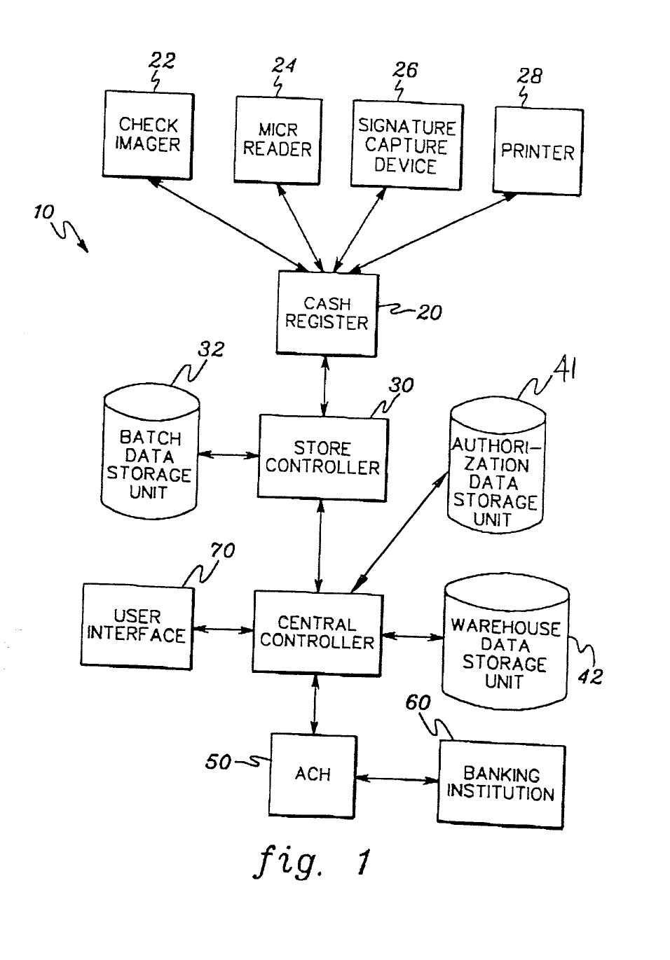

FIG. 1 illustrates a block diagram of one embodiment of a system 10 for processing checks using a blank check according to the present invention. While the present invention is described in connection with multi-lane retailers such as a retail grocery store, it will be appreciated that the systems and methods of the present invention are suitable with other types of operations in which checks are tendered for payment of goods or services.

In this exemplary embodiment, system 10 generally includes a point-of-sale terminal or cash register 20 which is connected to a check imager 22, a MICR (magnetic ink character recognition) reader 24, an electronic signature capture device 26, and a printer 28. Cash register 20 is also operably connected to a local computing unit or store controller 30 may also be operably connected to a plurality of cash registers (only one of which is shown in FIG. 1), each of which may be located at a respective one of a plurality of checkout lanes via, for example, an in-store local area network. Store controller 30 is also operably connected to a batch data storage unit 32, and to a remote computing unit or central controller 40 which may be operably connected to a plurality of store controllers (only one of which is shown in FIG. 1), each of which may be located at a respective one of a plurality of stores via, for example, a communication network such as a telephone system, a global communications network such as the Internet, or other suitable communications network. Central controller 40 may be connected to a warehouse data storage unit 42, an authorization data storage unit 41, and to an automated clearing house (ACH) 50 which in turn is operably connectable to one or more banking institutions 60 (only one of which is shown in FIG. 1). It will be appreciated that instead of an ACH, the central controller may be operably connectable to the Federal Reserve, shared bank network, a bank, credit card network, or other suitable means for settlement.

As explained in greater detail below, the system integrates electronic check processing into retail operations and allows customers to pay for goods or services, such as items at a grocery checkout, with a blank check and without writing out and/or signing the blank check. Allowing a customer to pay with a blank check reduces the time required for completing the point-of-sale transaction for the customer and for the retailer. In addition, allowing a customer to pay with a blank check reduces the likelihood of errors and the likelihood of reconciliation adjustments for the customer and the retailer. Capturing an image of the blank check and an electronic image of the customer's handwritten signature allows archival and retrieval for use in, for example, proving or collecting payment in the case where the check was drawn on an account with insufficient funds or where the customer tendered the check fraudulently. Capturing both the image of the face of the blank check and having the customer provide a handwritten signature at the point-of-sale results in two items of data for archival and retrieval. As further described in greater detail below, other types of biometric information from the customer may be used instead of obtaining a handwritten signature from the customer. In addition, it will be appreciated that more than one type of biometric information may be obtained from the customer and stored in the methods and systems of the present invention.

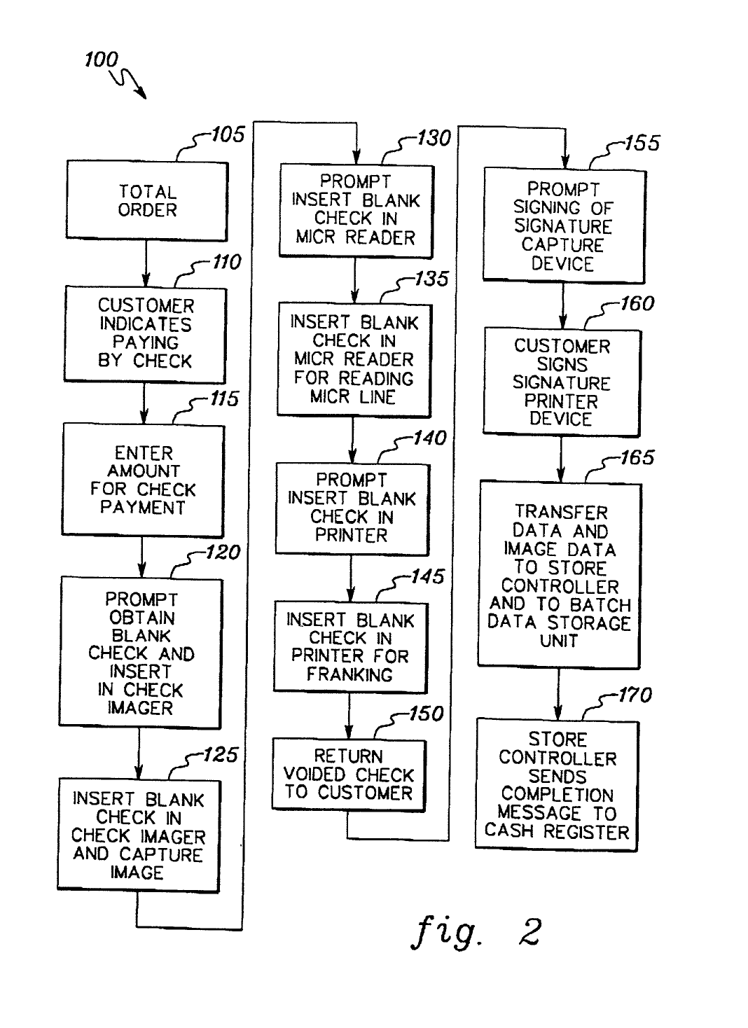

FIG. 2 illustrates a flowchart of one embodiment of a check processing process 100 with a blank check at a point-of-sale using the system shown in FIG. 1. Initially, at 105, the customer's order is totaled on the cash register. If the customer indicates that he or she will be paying by check, at 110, the sales clerk enters the amount of the check payment into the cash register 20 (FIG. 1) at 115. Alternatively, the sales clerk may be required to press a button on the cash register to indicate that payment is by check.

At 120, the cash register terminal prompts the sales clerk to obtain a blank check from the customer and insert the blank check in check imager 22 (FIG. 1). After the sales clerk receives the blank check from the customer, e.g., the customer need not fill in the amount of the transaction, the payee, or sign or date the check, the sales clerk inserts the customer's blank check in the check imager for scanning and obtaining an electronic image of a face of the blank check, at 125.

At 130, the cash register prompts the sales clerk to insert the blank check in MICR reader 24 (FIG. 1). The customer's blank check is inserted in the MICR reader, at 135, for reading and obtaining the routing number, account number, and check number from the MICR line at the bottom of the check.

The cash register then prompts the sales clerk to insert the blank check in printer 28 (FIG. 1), at 145. Inserting the blank check in the printer allows for franking such as printing on the front of the check, for example, “VOID”, ACH required or other required terms and conditions, transaction amount, transaction date, store location, at 145. Thereafter, the sales clerk returns the voided check to the customer, at 150.

At 155, the cash register prompts the sales clerk to instruct the customer to sign signature capture device 26 (FIG. 1). Alternatively, the signature capture device can be configured to prompt the customer, for example, via a display which indicates to the customer the need to sign the signature capture device. In addition, the signature capture device may have a display which displays the check image, the ACH required or other required terms and conditions. It will be appreciated that the customer may be required to sign the signature capture device prior to the sales clerk inserting the blank check into the printer for franking. At 160, the customer signs the signature capture device using a stylus.

At 165, the cash register then transfers the transaction data and image data, e.g., an electronic image of the blank check, electronic image of the customer's handwritten signature, the customer identification, the transaction amount, the transaction date and time, the check number, the MICR code, the store location, lane location identifier, and/or the clerk identifier via store controller 30 (FIG. 1) for storage.

For example, a first generated output may be customer data which is transferred via the store controller and central controller to authorization data storage unit 41 (FIG. 1) for use in determining the check cashing privileges of the customer, as described in greater detail below, and which need not include the image data. For example, the authorization data may include the customer identification, the transaction amount, the transaction date and time, the check number, the MICR code, the store location, lane location identifier, and/or the clerk identifier.

A second generated output may be the transaction data and image data, e.g., an electronic image of the blank check, electronic image of the customer's handwritten signature, the customer identification (e.g., store issued identification card, driver's license, other identification), the transaction amount, the transaction date and time, the check number, the MICR code, the store location, lane location identifier, and/or the clerk identifier, which is transferred via store controller to batch data storage unit 32 (FIG. 1).

After the two outputs are transferred and stored in the data storage units, e.g., on the hard drive of the store controller and/or central controller, the store controller sends a completion message to the cash register indicating the end of the transaction, at 170. Alternatively, the cash register may send the transaction and image data to the store controller and the store controller then generates and forwards the required data to the batch data storage unit and to the authorization data storage unit.

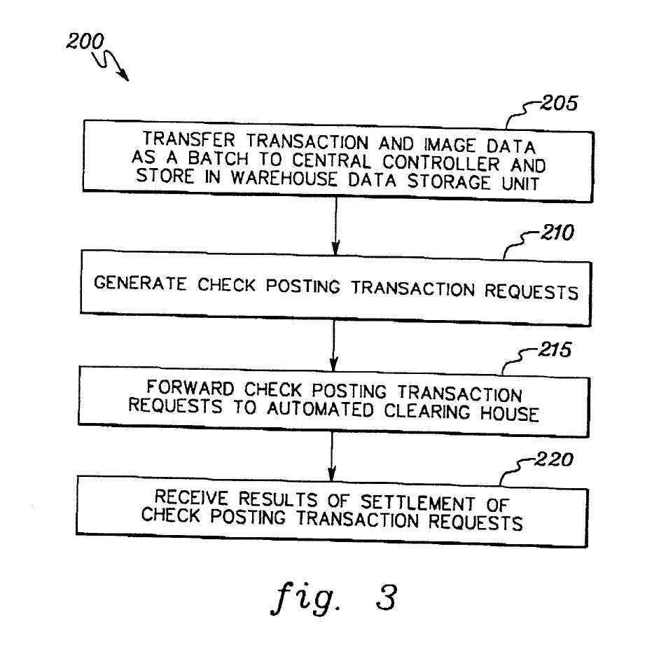

FIG. 3 illustrates one embodiment of a batch check processing process according to the present invention. During a scheduled off-peak time each day or other appropriate interval, the transaction and image data that has been stored in the batch data storage unit 32 (FIG. 1) is transferred via store controller 30 (FIG. 1) to central controller 40 (FIG. 1) for storage in warehouse data storage unit 42 (FIG. 1) at 205, which may be owned and maintained by the retailer. The transfer of data may utilize any number of techniques such as FTP or other suitable file transfer protocol. When the data arrives at the warehouse data storage unit, it may be saved in a designated location corresponding to store or site number. The information stored in the warehouse data storage unit, may be accessible via a settlement user interface 70 (FIG. 1) as described below.

Once all the transaction and image data has been collected from the various store controllers for the various stores, a batch process is run by central controller 40 (FIG. 1) on the transaction and image data in the warehouse data storage unit. For example, at 210, a plurality of electronic check posting transaction requests is generated and forwarded, at 215, to ACH 50 (FIG. 1) via FTP or another suitable file transfer protocol or other appropriate electronic transfer method. An electronic check posting transaction may include the transaction amount, the transaction time, the transaction date, the MICR code, the store location identifier, lane location identifier, clerk identifier, and/or customer identifier.

After the ACH process is completed by the ACH, the ACH sends, at 220, an electronic file containing settlement data for each item, e.g., index information and appropriate settlement indicator designating the result of the item's presentation for settlement, to central controller 40 (FIG. 1). This file may be stored in the warehouse data storage unit with the check posting transaction requests and/or indexed for retrieval via settlement user interface 70 (FIG. 1).

If an electronic check posting transaction request presented for settlement is not processable, it may be automatically queued for electronic draft submission. For example, the ACH creates the electronic drafts for those checks queued and presents each to the appropriate institution. Any checks which are not processable and are not cleared by electronic draft are combined with any records that are processed but are declined by the institution (non sufficient funds, closed account, etc.). These records can be sent electronically to the retailer's collection agents for resolution.

With reference again to FIG. 1, user interface 70 may be provided as a query tool designed to assist customer service, check collection and settlement agents in researching and proving transactions. Desirably, the interface is in the form of a point and click interface that allows the user to search for transactions by any of the indexes in the warehouse data storage unit. The interface may combine the transaction information with the check image and signature image into a completed check image. The agent will then be able to view, print or e-mail the completed check image as necessary. Access to this information is desirably read-only in that agents will not be able to change transaction information that is stored in the warehouse data storage unit. In the event of fraud, the settlement user interface may allow retrieval of the transaction data, check image, signature image, check posting transaction request, and the settlement data.

The warehouse data storage unit may be owned and maintained by a retailer or by an ACH. Where the warehouse data storage unit is owned by an ACH, data received from the store controller is saved to a designated location, for example, corresponding to the company and store or site number. Once all of the data has been collected from the various store controllers, a batch process may be run on the checks for settlement.

In an alternative embodiment, the system may be configured to provide on-line check posting, e.g., generating electronic check posting transaction requests at the time of the point-of-sale. For example, as described above, store controller 30 (FIG. 1) which stores the transaction and image data in the batch data storage unit may also generate a check posting transaction request by removing the electronic image of the face of the blank check and electronic image of the signature from the transaction and image data. The check posting transaction request may be stored in the batch data storage unit.

The store controller may also forward the check posting transaction request to the central controller. The store controller may also provide a completion message which is sent to the cash register to indicate that the check posting transaction request has been generated. In addition, the store controller may forward a plurality of check posting transaction requests as a batch via a communication network to an ACH for settlement. The output of electronic records produced by the ACH may be reconciled or confirmed with the check posting transaction requests produced by the store controller. In addition, the cash register may be operable for generating a check posting transaction request and operably connected via a communication network for forwarding in real-time the check posting transaction request for settlement.

In another embodiment, the system may include a preauthorization feature for determining a customer's check cashing privileges prior to the customer indicating payment by check, or a check authorization feature where the customer indicates payment by check prior to totaling the items for sale. For example, prior to, during, or after totaling of the customer's grocery items to be purchased, the customer provides identification to the sales clerk such as store issued identification card, a personal identification number, a driver's license, biometric information (as described in greater detail below) or other identification or combinations thereof. The cash register may include a keyboard, a magnetic stripe reader, a bar code reader, etc., for entering the customer's identification. Thereafter, the customer's identification is returned to the customer. Separate devices such a stand alone magnetic card stripe reader or a PIN pad may also be attached to the cash register.

The information regarding the customer's identification may be forwarded via the store controller to the central controller where the information is then used in retrieving, for example, the customer's current check cashing privileges, available limits, number of checks presented during the last week (e.g., checking velocity), etc., from a preauthorization or check authorization data storage such as the authorization data storage unit 41 (FIG. 1) attached to the central controller. Alternatively, the customer's identification information may be forwarded to a local authorization system which is operably connectable to the store controller or to an external host authorization system such as a third-party check authorization system or a third-party check guarantee system for providing the customer's current check cashing privileges, available limits, etc. via a communications network.

The result, e.g., approval or denial of check cashing privileges, of the preauthorization or check authorization process is transferred from the store controller to the cash register and displayed on a display of cash register for observation by the cashier, or the result may be stored and used for determining whether the total of items to be purchased by the customer using a check is permitted.

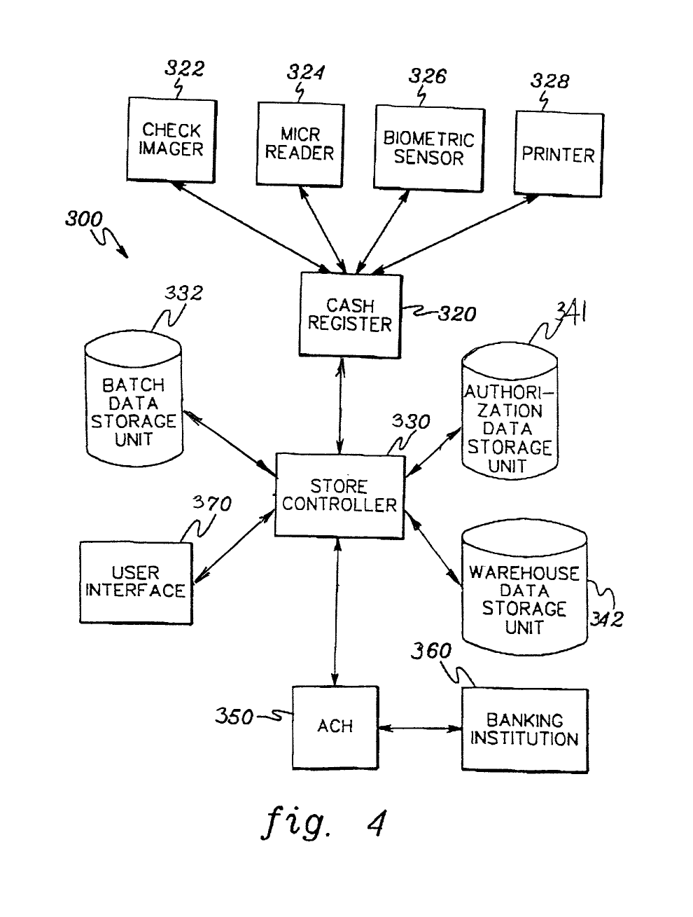

FIG. 4 illustrates a system 300 according to another embodiment of the present invention for on-line or real-time check processing of a check using a blank check at a point-of-sale. In this illustrated system, system 300 generally includes a point-of-sale terminal or cash register 320 which is connected to a check imager 322, a MICR (magnetic ink character recognition) reader 324, a biometric sensor 326, and a printer 328.

Cash register 220 is also operably connected to a store controller 330. Store controller may also be operably connected to a batch data storage unit 332, an authorization data storage unit 341, a warehouse data storage unit 342, a user interface 370, and an ACH 350 which is operably connected to a banking institution 360. As noted above, it will be appreciated that instead of an ACH, the central controller may be operably connectable to the Federal Reserve, shared bank network, a bank, credit card network, or other suitable means for settlement.

In this illustrated embodiment, biometric sensor 326 is operable to obtaining biometric information from the customer. As noted above the biometric sensor may be a signature capture device for obtaining an image of the handwriting signature of the customer. Biometric sensor 326 may also include, for example, a fingerprint scanner for capturing an electronic information regarding a user's fingerprint, a retina or iris scanner for capturing electronic information regarding the blood vessel patterns of the retina and the pattern of flecks on the iris, a video or digital camera for capturing electronic information regarding the face of the customer, a microphone for capturing a voice print or sample of the customer, or a number pad or keyboard pad for obtaining the password of the customer along with the rate of typing and intervals between letters. By capturing an image of the blank check and biometric information, two items of separate information may be stored in the warehouse data storage unit and allow archival and retrieval for use in, for example, proving or collecting payment in the case where the check was drawn on an account with insufficient funds or where the customer tendered the check fraudulently. In addition, the biometric information may be used identification purposes as well in an authorization process and compared with data in an authorization data storage unit. In addition, it will be appreciated that other biometric sensors may be employed in the methods and systems of the present invention for obtaining other biometric information or other personal information particular to the customer.

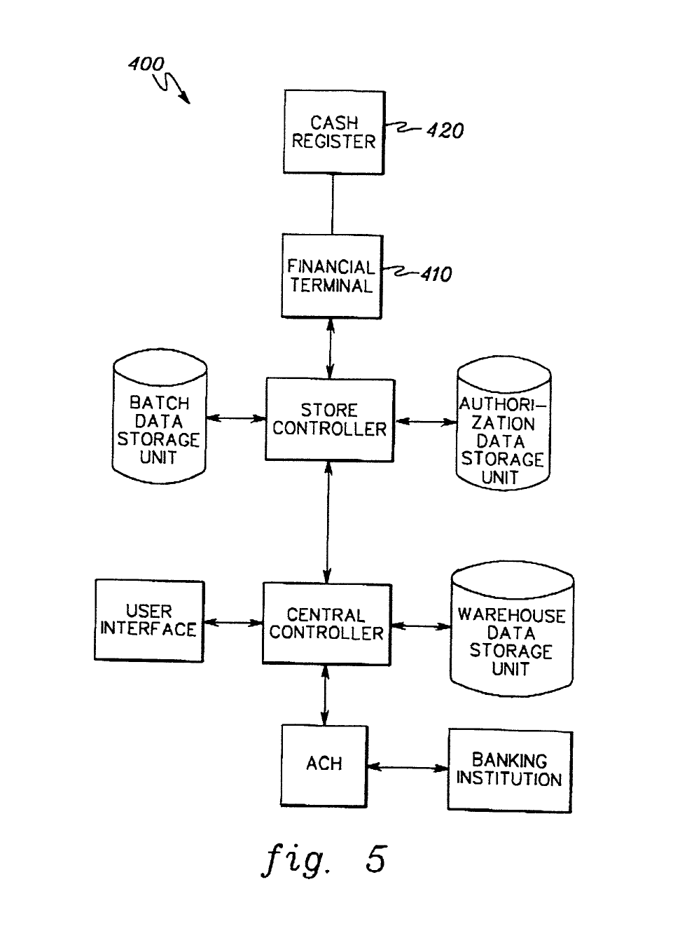

FIG. 5 illustrates a system 400 according to another embodiment of the present invention for processing a check using a blank check at a point-of-sale. In this illustrated system, a financial terminal 410 is provided which is connectable to a cash register 420, such as a preexisting cash register with limited functions, and to a store controller 430 via a communications network. The financial terminal 410 may be integral with or operably connectable to a biometric sensor, an image capture device, a MICR reader, a printer, or combinations of two or more of such devices. Such a setup desirably reduces the sales clerk or the customer's handling of the paper check as described below.

A check processing process with a blank check using the system shown in FIG. 5 includes, the customer's order initially being subtotaled on the cash register. If the customer indicates that he or she will be paying by check, the sales clerk may indicate on the cash register that payment is by check, e.g., presses a button or enter the amount of the check payment into the cash register or financial terminal, or the customer may press an appropriate button on the financial terminal.

The cash register may then prompt the sales clerk to request a blank check from the customer. As described above the customer need not fill in the amount of the transaction, the payee, or sign or date the check. The sales clerk then inserts the customer's blank check in the image capture device, the MICR reader, and the printer device. Alternatively, the customer may be prompted, e.g., instructed by the sales clerk or instructed by a display on the financial terminal to insert a blank check into a combination image capture MICR reader, and printer device.

After insertion of the blank check, the check imager then optically scans the face of the check, the MICR reader reads the MICR routing, account, and check number from the MICR line on the bottom of the check, and the printer franks, prints “VOID”, the transaction amount, transaction date, and store/terminal location, etc., on the front of the check. The financial terminal may display the ACH required or other terms and conditions, and prompt the customer to sign the signature capture device using a stylus.

Thereafter, the financial terminal transfers the electronic image of the face of the blank check, the biometric information, the transaction information (transaction amount, checking account information, any customer identification, etc.) to the store controller for storage in the batch storage unit and subsequent processing as described above.

The cash register, store controller, and the central controller may include, for instance, a processor, such as a processor or computing unit with Microsoft WINDOWS as the operating system, and based on the Intel PC architecture. The store controller and the central controller may also include a suitable LINUX, NT Workstation, or VOS controller. In addition, the various devices, e.g., check imager, MICR reader, signature capture device, may be operable to initially store the respective electronic image of the face of the blank check, MICR code, and biometric information, or transfer to the store controller without storing to the cash register or the financial terminal.

Other features of the present system may include the customer inserting a blank check into a combination check imager, MICR reader, and printer device prior to the sales clerk totaling the various items to be purchased. In addition, the MICR line may be used as the customer identification information for preauthorizing the tendering of payment by check by the customer. Further, the blank check may remain in the combination check imager, MICR reader, and printer device during preauthorizing, totaling of the sale, capturing an image of the face of the blank check, capturing biometric information, and voiding of the check.

Still other features of the various described systems may include allowing the customer to obtain cash back from the retailer, e.g., the transaction amount is the sales amount plus the amount of cash to be provided to the customer and any applicable cashback service fees. The franking of the blank check may be carried out by the sales clerk with a stamp and inkpad where, for example, a printer is not available. In addition, each transaction and image data and/or check posting transaction request may be sent directly from the cash register or financial terminal via a communications network to the warehouse data storage unit, e.g., in addition to or bypassing the store controller, or where the retail store is not provided with a store controller. Further, each check posting transaction request may be sent in real-time directly from the cash register or financial terminal via a communications network to an ACH and/or as well as to the central controller. The storage of the various data may be in a compressed file format.

From the present description, it will be appreciated that one or more of the various aspects of the check imager, MICR reader, biometric sensors, printer, cash register, financial terminal, store controller, and central controller may be operably combined in one or more devices according to the present invention. The various described methods for processing a check using a blank check may utilize a combination check imager and MICR reader, or a financial terminal for use with preexisting cash registers may be provided with a biometric sensor as well as a combination check imager, MICR reader, and printer. The check imagers may include an optical read head suitable sized for scanning generally the entire surface of the front of the blank check upon the check being passed by the optical read head, and/or suitably sized, e.g., less than the length or width of a check, where the optical read head is operably moved over generally the entire surface area of the face of the blank check. Suitable devices having an optical scanner, a MICR reader, and/or a printer are disclosed in U.S. Patent No. 5,832,463 issued to Funk, U.S. Pat. No. 5,053,607 issued to Carlson et al., U.S. Pat. No. 6,164,528 issued to Hills et al., and U.S. Pat. No. 6,257,783 to Hanaoka et al., the entire subject matter of these patents being incorporated herein by reference.

From the present description, it will also be appreciated by those skilled in the art that various combinations of the various aspects of the disclosed methods for check processing using a blank check, e.g., preauthorization, check authorization, on-line generation of check posting transaction request, etc. may be combined in further systems and method according to the present invention. In addition, an authorization data storage unit or negative file may be connected to the store controller. Further, while it is desirable that the user not complete or write out the check, it will be appreciated that the above-described methods for processing a check using a blank check would be operable even if a customer in a check out line wrote out one or more items on the check.

In addition, one or more stores may share a controller such as a store controller. Such a shared controller may be suitable where a store's primary (or normal) store controller experiences a hardware failure (e.g., where a hard drive or a mother board dies). The shared controller may also reside in a different physical location than the store where the transaction or point-of-sale is conducted.

Thus, while various embodiments of the present invention have been illustrated and described, it will be appreciated to those skilled in the art that many changes and modifications may be made thereunto without departing from the spirit and scope of the invention.

1. A method for enabling check processing using a blank check, the method comprising:
receiving a transaction amount, checking account information from a blank check, and an electronic image of a face of the blank check.

2. The method of claim 1 further comprising receiving biometric information from an owner of the checking account.

3. The method of claim 1 further comprising receiving an electronic image of a handwritten signature from an owner of the checking account.

4. The method of claim 1 further comprising at least one of receiving information regarding a fingerprint of an owner of the checking account, information regarding a retina or an iris of the customer, an image of a face of the customer, a voice print of the customer, and a personal identification number.

5. The method of claim 1 further comprising storing the transaction amount, the checking account information, and the electronic image of a face of the blank check.

6. The method of claim 1 further comprising generating an electronic check posting transaction request from the transaction amount and the checking account information.

7. The method of claim 6 further comprising forwarding the electronic check posting transaction request for settlement.

8. The method of claim 1 further comprising storing a plurality of transaction amounts, a plurality of checking account information, and a plurality of electronic images of faces of blank checks, and transferring as a batch the plurality of transaction amounts, the plurality of checking account information, and plurality of electronic images of the faces of the blank checks to a warehouse data storage unit.

9. A method for enabling check processing using a blank check, the method comprising:
receiving a transaction amount, checking account information from a blank check, and biometric information from an owner of the checking account.

10. The method of claim 9 wherein the receiving the biometric information comprises receiving an electronic image of a handwritten signature, separate from the blank check, from an owner of the checking account.

11. The method of claim 9 wherein the receiving the biometric information comprises at least one of receiving information regarding a fingerprint of an owner of the checking account, information regarding a retina or an iris of the customer, an image of a face of the customer, a voice print of the customer, and a personal identification number along with the rate of typing and intervals for entry of the personal identification number.

12. The method of claim 9 further comprising storing the transaction amount, the checking account information, and the biometric information.

13. The method of claim 9 further comprising generating an electronic check posting transaction request from the transaction amount and the checking account information.

14. The method of claim 13 further comprising forwarding the electronic check posting transaction request for settlement.

15. The method of claim 9 further comprising storing a plurality of transaction amounts, a plurality of checking account information, and a plurality of biometric information, and transferring as a batch the plurality of transaction amounts, the plurality of checking account information, and plurality of biometric information to a warehouse data storage unit.

16. A method for check processing using a blank check, the method comprising:
receiving a transaction amount, checking account information from a blank check, an electronic image of a face of the blank check, and biometric information from an owner of the checking account;
generating an electronic check posting transaction request from the transaction amount and the checking account information; and
forwarding the electronic check posting transaction request for settlement.

17. The method of claim 16 wherein the receiving the biometric information comprises receiving an electronic image of a handwritten signature from an owner of the checking account.

18. The method of claim 16 wherein the receiving the biometric information comprises at least one of receiving information regarding a fingerprint of an owner of the checking account, information regarding a retina or an iris of the customer, an image of a face of the customer, a voice print of the customer, and a personal identification number.

19. The method of claim 16 wherein the receiving the electronic image of the face of the blank check comprises obtaining the electronic image of the face of the blank check from an imager, and the receiving the biometric information comprises obtaining the electronic image of the handwritten signature from a signature capture device.

20. The method of claim 16 further comprising storing the transaction amount, the checking account information, the electronic image of a face of the blank check, and the biometric information.

21. The method of claim 16 further comprising storing electronic information regarding settlement of the check posting transaction request.

22. The method of claim 16 further comprising storing a plurality of transaction amounts, a plurality of checking account information, and the plurality of electronic images of faces of blank checks, and a plurality of biometric information, and transferring as a batch the plurality of transaction amounts, the plurality of checking account information, the plurality of electronic images of the faces of the blank checks, and a plurality of the biometric information to a warehouse data storage unit.

23. A method for enabling check processing using a blank check at a point-of-sale, the method comprising:
receiving at the point-of-sale a blank check from a customer at the point-of-sale;
receiving at the point-of-sale a transaction amount, checking account information from a blank check, an electronic image of a face of the blank check, and biometric information from the customer;
storing the transaction amount, the checking account information, the electronic image of the blank check, and the biometric information;
printing indicia on the face of the blank check to void the blank check; and
returning the voided blank check to the customer.

24. The method of claim 23 wherein the receiving the biometric information comprises receiving an electronic image of a handwritten signature from the customer.

25. The method of claim 23 wherein the receiving the biometric information comprises at least one of receiving information regarding a fingerprint of an owner of the checking account, information regarding a retina or an iris of the customer, an image of a face of the customer, a voice print of the customer, and a personal identification number.

26. The method of claim 23 wherein the receiving the transaction amount, the checking account information, the image of the blank check, and the biometric information comprises obtaining the transaction amount from a cash register, obtaining the checking account information from a magnetic ink character recognition reader, obtaining the electronic image of the blank check from an imager, and obtaining the biometric information from a biometric sensor.

27. The method of claim 23 wherein the receiving the biometric information comprises obtaining the biometric information from a financial terminal comprising a biometric sensor, the financial terminal being connectable to a communications network and to a cash register.

28. The method of claim 27 wherein the financial terminal further comprises a magnetic ink character recognition reader for obtaining the checking account information, and an imager for obtaining the electronic image of the face of the blank check.

29. The method of claim 28 wherein the financial terminal further comprises a printer for printing the indicia on the face of the blank check.

30. The method of claim 23 further comprising determining the check cashing privileges of the customer.

31. A method for check processing using a blank check at a point-of-sale, the method comprising:
receiving at the point-of-sale a blank check from a customer;
receiving at the point-of-sale a transaction amount, checking account information from a blank check, an electronic image of a face of the blank check, and biometric information from the customer;
storing the transaction amount, the checking account information, the electronic image of the blank check, and the biometric information;
printing indicia on the face of the blank check to void the blank check;
returning the voided blank check to the customer;
generating an electronic check posting transaction request from the transaction amount, and the checking account information; and
forwarding the electronic check posting transaction request for settlement.

32. The method of claim 31 wherein the receiving the biometric information comprises receiving an electronic image of a handwritten signature from the customer.

33. The method of claim 31 wherein the receiving the biometric information comprises at least one of receiving information regarding a fingerprint of an owner of the checking account, information regarding a retina or an iris of the customer, an image of a face of the customer, a voice print of the customer, and a personal identification.

34. The method of claim 31 wherein the receiving the transaction amount, the checking account information, the image of the blank check, and the biometric information comprises obtaining the transaction amount from a cash register, obtaining the checking account information from a magnetic ink character recognition reader, obtaining the electronic image of the blank check from an imager, and obtaining the biometric information from a biometric sensor.

35. The method of claim 31 wherein the receiving the biometric information comprises obtaining the biometric information from a financial terminal comprising a biometric sensor, the financial terminal being connectable to a communications network and to a cash register.

36. The method of claim 35 wherein the financial terminal further comprises a magnetic ink character recognition reader for obtaining the checking account information, and an imager for obtaining the electronic image of the face of the blank check.

37. The method of claim 36 wherein the financial terminal further comprises a printer for printing the indicia on the face of the blank check.

38. The method of claim 31 further comprising determining the check cashing privileges of the customer.

39. The method of claim 31 further comprising storing electronic information regarding settlement of the check posting transaction request.

40. A method for warehousing information relating to check transactions, the method comprising:
storing in at least one data storage unit a transaction amount, checking account information from a blank check, an electronic image of a face of the blank check, and biometric information from the owner of the checking account.

41. The method of claim 40 wherein the biometric information comprises an electronic image of a handwritten signature from an owner of the checking account.

42. The method of claim 40 wherein the biometric information comprises information regarding a fingerprint of an owner of the checking account, information regarding a retina or an iris of the customer, an image of a face of the customer, a voice print of the customer, and a personal identification number.

43. The method of claim 40 further comprising storing in the at least one data storage unit information regarding settlement of a check posting transaction request based on the transaction amount and the checking account information.

44. A system for enabling check processing using a blank check, the system comprising:
a processor for receiving a transaction amount, checking account information from a blank check, an electronic image of a face of the blank check, and biometric information from an owner of the checking account; and
said processor operable for transferring the transaction amount, the checking account information, the electronic image of a face of the blank check, and the biometric information to a data storage unit.

45. The system of claim 44 wherein said processor is operable for generating a check posting transaction request from the transaction amount and the checking account information for settlement.

46. The system of claim 45 wherein said processor is operable to forward the check posting transaction request over a communications network for settlement.

47. The system of claim 44 further comprising a signature capture device for obtaining the biometric information comprising an electronic image of a handwritten signature from the owner of the checking account.

48. The system of claim 44 further comprising a biometric sensor for obtaining the biometric information comprising information regarding a fingerprint of an owner of the checking account, information regarding a retina or an iris of the customer, an image of a face of the customer, a voice print of the customer, and a personal identification number.

49. A system of claim 44 further comprises a cash register comprising said processor.

50. A system of claim 44 further comprising a financial terminal comprising said processor, and said financial terminal being connectable to a cash register.

51. A system of claim 50 wherein said financial terminal comprises a signature capture device for obtaining the biometric information comprising an electronic image of a handwritten signature from the owner of the checking account.

52. A system of claim 44 further comprising a magnetic ink character recognition reader for obtaining the checking account information, and an imager for obtaining the electronic image of the face of the blank check.

53. A system of claim 44 further comprising a printer for printing the indicia on the face of the blank check.

54. At least one program storage device readable by a machine, tangibly embodying at least one program of instructions executable by the machine to perform a method for enabling check processing using a blank check, the method comprising:
receiving a transaction amount, checking account information from a blank check, an electronic image of a face of the blank check, and biometric information from an owner of the checking account; and
transferring the transaction amount, the checking account information, the electronic image of the face of the blank check, and the biometric information to a data storage unit.

55. The at least one program storage device of claim 54 further comprising generating an electronic check posting transaction request from the transaction amount and the checking account information.

56. The at least one program storage device of claim 55 further comprising receiving information regarding settlement of the check posting transaction request, and storing the information regarding settlement of the check posting transaction request.

57. An article of manufacture comprising:
at least one computer usable medium having computer readable program code means embodied therein for use in check processing using a blank check, the computer readable program code means in said article of manufacture comprising:
computer readable program code means for causing a computer to receive a transaction amount, checking account information from a blank check, an electronic image of a face of the blank check, and biometric information from an owner of the checking account;
computer readable program code means for causing a computer to generate an electronic check posting transaction request from the transaction amount and the checking account information; and
computer readable program code means for causing a computer to forward the electronic check posting transaction request for settlement.

58. The article of manufacture of claim 57 further comprising computer readable program code means for causing a computer to store the transaction amount, the checking account information, the electronic image of the face of the blank check, and the biometric information.

59. The article of manufacture of claim 58 further comprising computer readable program code means for causing a computer to receive and store information regarding settlement of the check posting transaction request.
